(19) United States
(12) Patent Application Publication
(10) Pub. No.: US 2013/0156956 A1
(43) Pub. Date: Jun. 20, 2013

(54) CARBON NANOTUBE PRODUCTION METHOD

(71) Applicants: Eiji Nakashima, Obu-shi (JP); Yosuke Koike, Sagamihara-shi (JP); Gang Xie, Anjo-shi (JP)

(72) Inventors: Eiji Nakashima, Obu-shi (JP); Yosuke Koike, Sagamihara-shi (JP); Gang Xie, Anjo-shi (JP)

(73) Assignee: AISIN SEIKI KABUSHIKI KAISHA, Kariya-shi, Aichi (JP)

(21) Appl. No.: 13/819,181

(22) PCT Filed: Sep. 2, 2011
(86) PCT No.: PCT/JP2011/070660

§ 371 Date: Feb. 26, 2013

(30) Foreign Application Priority Data
Sep. 22, 2010 (JP) 2010-211617

(51) Int. Cl. C01B 31/02

(52) U.S. Cl. CPC C01B 31/0233; Y10S 977/843; B82Y 40/00
USPC 427/301; 977/843

(57) ABSTRACT

A carbon nanotube production method forms a carbon nanotube aggregate having a high perpendicular orientation characteristic where a plurality of carbon nanotubes are aligned in a direction perpendicular to a surface of a substrate, without using terpineol, which is a viscosity improver. A catalyst solution having a predetermined concentration (from 0.2 M to 0.8 M) of a transition metal salt dissolved therein, and free of terpineol is prepared. Catalyst particles are caused to be present on the surface of the substrate by making the catalyst solution contact with the surface of the substrate. By making a carbon nanotube forming gas contact with the surface of the substrate in a carbon nanotube forming temperature region, the carbon nanotube aggregate is grown on the surface of the substrate where a plurality of carbon nanotubes are aligned in the direction perpendicular to the surface of the substrate.

### TECHNICAL FIELD

The present invention relates to a carbon nanotube production method for manufacturing a carbon nanotube aggregate having a high perpendicular orientation characteristic on a surface of a substrate where a plurality of carbon nanotubes are aligned in a direction perpendicular to the surface of the substrate.

### BACKGROUND ART

A carbon nanotube is a carbonaceous material attracting attentions in recent years. Patent Document 1 discloses a method to orient a carbon nanotube aligned in a direction perpendicular to a surface of a substrate by forming a catalyst layer on a surface of a base plate by using a catalyst solution, which is formed by dissolving a transition metal salt in a liquid that is a mixture of ethanol and terpineol, followed by chemical vapor deposition (CVD).

According to this disclosure, the catalyst solution contains terpineol so that viscosity of the catalyst solution increases. In a state where viscosity of the catalyst solution increases, the carbon nanotube is considered to grow favorably because thickness of the catalyst solution that is applied on the surface of the substrate increases and catalyst particles are appropriately distributed on the surface of the substrate.

Patent Document 2 discloses a technology to enhance evenness of catalyst applied on a base plate by providing a hydrophobic treatment on a surface of the base plate made of silicon by processing with octadecene and then forming a hydrophilic surface on the surface of the base plate that is provided with the hydrophobic treatment with a surfactant to enhance hydrophilic property between a catalyst solution and the base plate.

Patent Document 3 discloses a method including processes processed in following order a process of forming a metallic precursor solution from a metal salt, a process of extracting a metallic precursor from the metallic precursor solution, a process of forming a liquid that is a mixture of the metallic precursor, a surfactant, and a solvent and making the liquid of the mixture to react at a temperature equal to or less than a boiling point of the solvent, a process of separating metal-containing nanoparticles from the liquid of the mixture, and a process of growing carbon nanotubes by the nanoparticles.

Patent Document 4 discloses a carbon nanotube production method that forms the carbon nanotubes by applying a carbon-containing compound gas on a base plate in a state where catalysts are supported on a surface of the base plate. According to the disclosure, the catalyst includes a fine particle containing a first element selected from group 8-10elements and a second element selected from group 4 elements and group 5 elements and a protective layer formed of an organic acid or an acid of organic amine that covers an area surrounding the fine particle.

Patent Document 1: JP2006-239618A

Patent Document 2: JP2008-56529A

Patent Document 3: JP2009-215146A

Patent Document 4: JP2007-261839A

### DISCLOSURE OF INVENTION

### Problems to be Solved by the Invention

The catalyst solution disclosed in Patent Document 1 contains terpineol having a characteristic to improve viscosity as an additive (where an amount of additive is from 20 to 40% ratio by weight). Terpineol is expensive and a production method using terpineol is disadvantageous with respect to cost. In addition, terpineol has high boiling point of 221 degrees Celsius, which requires a drying temperature equal to or more than 221 degrees Celsius and a long time to remove terpineol, which results in decreasing productivity of the carbon nanotubes. Furthermore, terpineol is highly viscous and decreases dissolving characteristic of the transition metal salt by inhibiting the transition metal salt dissolving in the solvent.

As specification of Patent Document 1 describes, the carbon nanotubes have a high perpendicular orientation characteristic in a state where concentration of the transition metal salt (which is nitrate salt) contained in the catalyst solution is low, the catalyst solution having the concentration of from 0.01 M to 0.05 M including 0.01 M and 0.05 M. The result is considered as an effect of terpineol, which is a viscosity improver, which makes film thickness of the catalyst solution that is applied on the surface of the base plate appropriate so that a distribution state of the catalyst particles becomes appropriate for providing a condition suitable for perpendicular orientation of the carbon nanotubes. Nevertheless, in a state where the concentration of the transition metal salt (which is nitrate salt) in the catalyst solution is high where the concentration is 0.1 M, although the carbon nanotubes are formed, an evaluation of homogeneity and the perpendicular orientation characteristic of the carbon nanotubes is extremely low and marked with an X. In a state where the concentration of the transition metal salt (which is nitrate salt) is even higher where the concentration is 0.2 M, although the carbon nanotubes are formed, an evaluation of homogeneity and the perpendicular orientation characteristic of the carbon nanotubes is extremely low and marked with a triangle. In a state where the concentration of the transition metal salt (which is nitrate salt) is still higher where the concentration is 0.5 M, although the carbon nanotubes are formed, an evaluation of homogeneity and the perpendicular orientation characteristic of the carbon nanotubes is extremely low and marked with an X. In other words, in a case where the catalyst solution contains terpineol, a range of applicable concentration that ensures the carbon nanotubes having a high perpendicular orientation characteristic is a range between the concentration of from 0.01 M to 0.05 M including 0.01 M and 0.05 M, meaning the catalyst solution that contains terpineol is disadvantageous in that the range of applicable concentration that ensures the carbon nanotubes having a high perpendicular orientation characteristic is limited to a narrow range.

A need thus exists for an invention according to this disclosure, which is a carbon nanotube production method to form a carbon nanotube aggregate having a high perpendicular orientation characteristic where a plurality of carbon nanotubes are aligned in a direction perpendicular to a surface of a substrate without using a catalyst solution containing tepineol.

### Means for Solving Problems

Inventors of present invention are deeply committed to the development of a carbon nanotube production method and obtained a knowledge that even without a process of mixing terpineol that functions as a viscosity improver in a catalyst solution, by using a high concentration catalyst solution provided with higher concentration of a transition metal salt where the concentration is from 0.2 M to 0.8 M including 0.2 M and 0.8 M, thickness of the catalyst solution that is applied on a surface of a substrate, for example a base plate, becomes appropriate so that catalyst particles formed by the catalyst solution may be appropriately distributed for providing a condition suitable for perpendicular orientation of the carbon nanotubes, and completed the carbon nanotube production method, which is the present invention, based on the obtained knowledge described herewith. According to the carbon nanotube production method according to the present invention, without mixing terpineol to the catalyst solution as a compounding ingredient, a carbon nanotube aggregate having a high perpendicular orientation characteristic where the carbon nanotubes are aligned in a direction perpendicular to the surface of the substrate may be manufactured.

Upon the arrangement described herewith, either using a catalyst solution containing low concentration of a transition metal salt where the concentration is less than 0.2 M or using a catalyst solution containing high concentration of the transition metal salt where the concentration is more than 0.8 M results in deteriorating the perpendicular orientation characteristic of the carbon nanotubes. Upon the arrangement described herewith, in a state where a low concentration catalyst solution is used, the catalyst particles formed by the transition metal salt provided on the surface of the substrate are assumed to form islands where the islands are dispersed in a state where each island is provided with excessive distance between neighboring islands. Under a condition described herewith, in a growing process of the carbon nanotubes, carbon nanotubes grow in a longitudinal direction in a state where neighboring carbon nanotubes may contact or approach one another, which is assumed to enhance the perpendicular orientation characteristic of the carbon nanotubes relative to the surface of the substrate. Under a condition described herewith, in a state where an excessively low concentration catalyst solution is used, the catalyst particles that become seeds to grow neighboring carbon nanotubes keep forming islands, however, separation distances between the islands become too much, which is assumed to result in carbon nanotubes unable to grow in the longitudinal direction while neighboring carbon nanotubes contact or approach one another, and results in a tendency for the carbon nanotubes to grow in random directions relative to the surface of the substrate.

In comparison, in a state where an excessively high concentration catalyst solution is used, the catalyst particles that become seeds to grow neighboring carbon nanotubes excessively agglomerate, which is assumed to result in carbon nanotubes unable to grow in the longitudinal direction while neighboring carbon nanotubes contact or approach one another, and results in a tendency for the carbon nanotubes to grow in random directions relative to the surface of the substrate.

As described above, the inventors of the present invention have obtained a knowledge that even without using terpineol, by using a high concentration catalyst solution provided with higher concentration of a transition metal salt where the concentration is from 0.2 M to 0.8 M including 0.2 M and 0.8 M, an amount of the transition metal salt dissolved and contained in the catalyst solution increases so that in a case where catalyst particles are prepared from a film of the catalyst solution provided on the surface of the substrate, the catalyst particles on the surface of the substrate are appropriately distributed to make the carbon nanotubes grow in a state where neighboring carbon nanotubes contact or approach one another, which enhances the perpendicular orientation characteristic of the carbon nanotubes relative to the surface of the substrate, and based on the obtained knowledge described above, the inventors have completed the carbon nanotube production method according to the present invention.

In other words, the carbon nanotube production method according to the present invention includes processes processed in following order, which are (i) a preparation process preparing a catalyst solution having a predetermined concentration by dissolving a transition metal salt in a solvent (where the concentration is from 0.2 M to 0.8 M including 0.2 M and 0.8 M), the catalyst solution free of terpineol, and preparing a substrate having a surface, (ii) a catalyst supporting process making the surface of the substrate to support catalyst particles by making the catalyst solution contact with the surface of the substrate, and (iii) a carbon nanotube growing process growing a carbon nanotube aggregate having a perpendicular orientation characteristic where the carbon nanotubes grow in a direction perpendicular to the surface of the substrate by making a carbon nanotube forming gas containing a carbon component contact with the surface of the substrate at a temperature within a carbon nanotube forming temperature region. A unit of M represents molarity (which is mole per liter), meaning mole number of a solute (a transition metal salt) dissolved in one liter of a catalyst solution.

The catalyst solution that the method according to the present invention uses does not contain terpineol, which is a viscosity improver, as an additive. Terpineol described here is one kind of monoterpene alcohol, which is obtained from cajuput oil, pine oil, petitgrain oil, or a similar material. As mentioned earlier, terpineol is expensive. With respect to cost, without using terpineol is an advantage. Accordingly, the catalyst solution used in the method according to the present invention is free of terpineol, therefore, temperature to remove terpineol from the carbon nanotubes after the carbon nanotubes are grown on the surface of the substrate is not required to be raised to the temperature equal to or more than the boiling point of the terpineol, which results in increasing productivity of the carbon nanotubes.

Furthermore, because the catalyst solution contains no terpineol, on dissolving the transition metal salt in the solvent, terpineol inhibiting the solubility of the transition metal salt is restrained so that solubility of the transition metal salt is ensured. In addition, a problem of a part of the transition metal salt separating as a product of oxidation is restrained so that the catalyst is restrained from deterioration. The catalyst solution, which is the transition metal salt dissolved in the solvent, does not contain terpineol, which is a viscosity improver, however, even without containing terpineol, the concentration of the catalyst solution is considered as high where the transition metal salt is dissolved to an amount that provides the catalyst solution with a concentration of from 0.2 M to 0.8 M including 0.2 M and 0.8 M. By making the catalyst solution having such high concentration contact with the surface of the substrate, thickness of the catalyst film formed on the surface of the substrate becomes not excessively thin nor excessively thick.

Here, in a state where the concentration of the catalyst solution is excessively low, the thickness of the catalyst film in liquid form provided on the surface of the substrate becomes excessively thin. In this case, the catalyst particles supported on the surface of the substrate stay in island forms while the islands are largely distanced between one another. In a state where the carbon nanotubes are grown on the surface of the substrate by catalysis of the catalyst particles in this instance, the carbon nanotubes are not aligned in the direction perpendicular to the surface of the substrate and tend to grow slanted relative to the surface of the substrate. In this case, formation of the carbon nanotubes having a high perpendicular orientation characteristic where the carbon nanotubes are aligned in the direction perpendicular to the surface of the substrate is difficult.

Note that, the carbon nanotubes that are aligned in the direction perpendicular to the surface of the substrate presumably form in a state where the catalyst particles supported on the surface of the substrate are appropriately distanced between one another where, due to the catalysis of the catalyst particles, the neighboring carbon nanotubes grow while contacting one another or while approaching one another.

In comparison, in a state where the concentration of the catalyst solution is excessively high, the thickness of the catalyst film in liquid form provided on the surface of the substrate becomes excessively thick. Presumably in this case, the catalyst particles supported on the surface of the substrate excessively agglomerate. In a state where the carbon nanotubues are grown on the surface of the substrate by catalysis of the catalyst particles in this instance, the carbon nanotubes are not aligned in the direction perpendicular to the surface of the substrate and tend to grow in various directions and as a result, the perpendicular orientation characteristic of the carbon nanotubes is considered to become rather random. In this case, formation of the carbon nanotubes having a high perpendicular orientation characteristic where the carbon nanotubes are aligned in the direction perpendicular to the surface of the substrate is considered difficult.

### Effects of the Invention

According to the production method according to the present invention, the carbon nanotube aggregate having a high perpendicular orientation characteristic is formed on the surface of the substrate where the carbon nanotubes are grown in the direction perpendicular to the surface of the substrate. According to the catalyst solution that the present invention uses, terpineol, which is an expensive viscosity improver, is not contained as an additive.

Accordingly, because the catalyst solution does not contain terpineol, which is a viscosity improver, the production method according to the present invention does not require heating temperature to be increased equal to or more than the boiling point of the terpineol to remove terpineol by transpiration. Accordingly, the productivity of the carbon nanotubes increases. Furthermore, because the catalyst solution contains no terpineol, which is a viscosity improver, the viscosity improver inhibiting dissolving of the transition metal salt on dissolving the transition metal salt in the solvent is restrained. As a result, solubility of the transition metal salt in the solvent is ensured. In addition, a problem of a part of the transition metal salt separating as a product of oxidation is restrained so that the catalyst is restrained from deterioration.

According to the production method according to the present invention, the catalyst solution, which is a transition metal salt dissolved in a solvent, is a high concentration solution having a concentration of from 0.2 M to 0.8 M including 0.2 M and 0.8 M even though the catalyst solution does not contain terpineol, which is a viscosity improver. By making the catalyst solution having such high concentration contact with the surface of the substrate, thickness of the catalyst film formed on the surface of the substrate becomes not excessively thin nor excessively thick. As a result, the catalyst particles supported on the surface of the substrate are appropriately distanced between one another and due to the catalysis of the catalyst particles, the neighboring carbon nanotubes grow while contacting one another or while approaching one another to provide the carbon nanotubes having a high perpendicular orientation characteristic where the carbon nanotubes are aligned in the direction perpendicular to the surface of the substrate.

The carbon nanotubes according to the present invention may be applicable to, for example, carbon materials used in a fuel cell, carbon materials used in electrodes of a capacitor, a lithium battery, a secondary battery, or a wet-type solar battery, and electrodes of industrial machines.

### BRIEF DESCRIPTION OF DRAWINGS

FIG. 1 is a group of images obtained by a scanning electron microscope where each image shows a test sample of carbon nanotubes manufactured by using a catalyst solution provided with different concentrations of transition metal salt and without containing terpineol.

FIG. 2 is an image obtained by a scanning electron microscope showing a test sample manufactured as a comparison sample where carbon nanotubes are manufactured by using a catalyst solution without containing terpineol.

FIG. 3 is a cross sectional view describing a fuel cell according to example of application 1.

FIG. 4 is a cross sectional view describing a capacitor according to example of application 2.

### EXPLANATION OF REFERENCE NUMERALS

102: gas diffusion layer for anode

103: catalyst layer for anode

104: electrolyte membrane

105: catalyst layer for cathode

106: gas diffusion layer for cathode

### MODE FOR CARRYING OUT THE INVENTION

A catalyst solution that a method of present invention uses does not contain terpineol, which is a viscosity improver. Furthermore, the catalyst solution is favorable not to contain sodium polyacrylate, polyvinyl alcohol, polyethylene oxide, polyvinylpyrrolidone, or essential oil, which are substances having a viscosity improving characteristic.

A transition metal that a transition metal salt contains serves as a catalyst metal. A group 5-8 metal is a favorable transition metal. Iron, nickel, and cobalt are examples of a transition metal in addition to molybdenum, copper, chromium, vanadium, nickel vanadium, titanium, platinum, palladium, rhodium, ruthenium, silver, gold, and alloys of these. Nitrate salt, chloride, bromide, organic complex salt, organic acid salt, boride, oxide, hydroxide, and sulfide are examples of the transition metal salt. Iron nitrate, iron nitrate, nickel nitrate, and cobalt nitrate are examples of nitrate salt. Iron nitrate may be iron (II) nitrate or iron (III) nitrate. Hexahydrate and nonahydrate are known. According to a literature, iron nitrate is generally known to be soluble, for example, in water, ethanol, and acetone. Iron chloride, nickel chloride, and molybdenum chloride are examples of chlorides. These are easily soluble in solvents, for example, ethanol and water. Iron chloride may be iron (II) chloride or iron (III) chloride.

Silicon, silicon nitride, silicon carbide, quartz, glass, ceramics, and a metal are examples of a base material of the substrate. Alumina and zirconia are examples of ceramics. Iron, iron alloy (stainless steel, for example), copper, copper alloy, titanium, titanium alloy, nickel, nickel alloy, and optionally, aluminum and aluminum alloy are examples of a metal.

Form of the substrate is not limited to any one form.

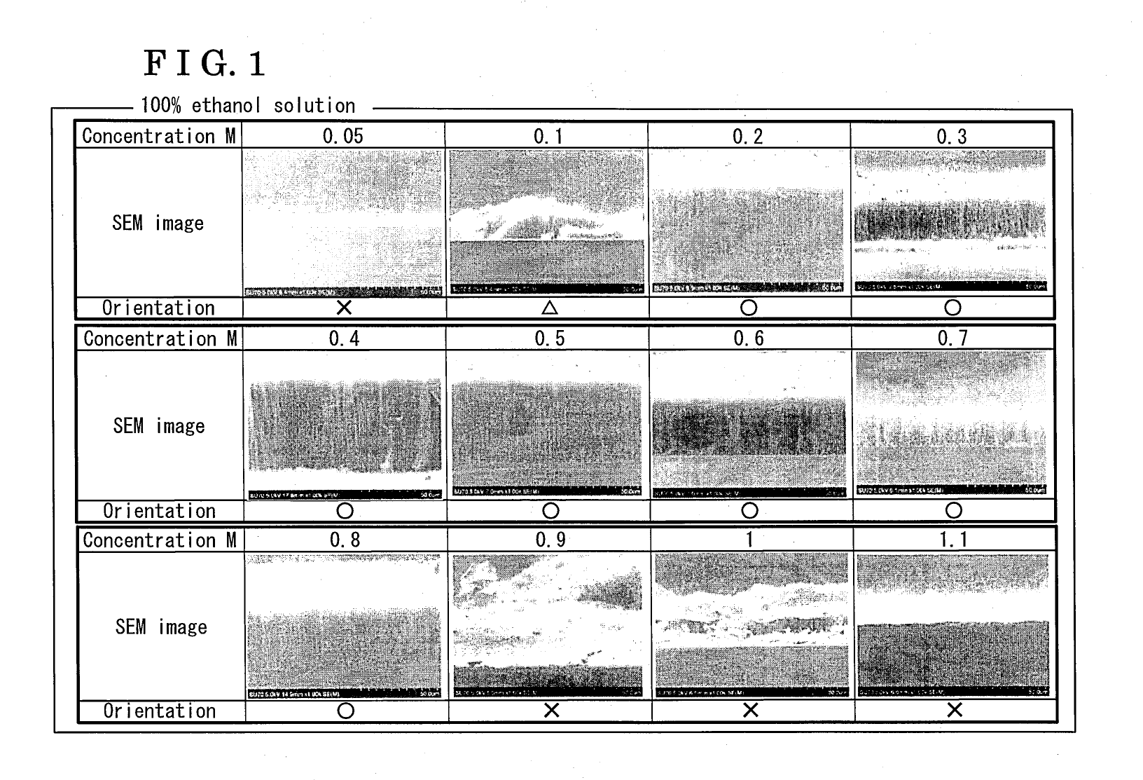

A carbon nanotube manufactured by the method according to the present invention is a graphene sheet in tubular form and includes the carbon nanotube in a horn form. The graphene sheet may be in one layer or in multiple layers. The catalyst solution prepared in a preparation process has a predetermined concentration (the concentration of from 0.2 M to 0.8 M including 0.2 M and 0.8 M) where a transition metal salt is dissolved in a solvent and free of terpineol, which is a viscosity improver. Referring to scanning electron microscope images shown in FIG. 1, the concentration of the catalyst solution, which is a transition metal salt dissolved in a solvent, is favorable in a range where the catalyst solution has a concentration of from 0.2 M to 0.8 M including 0.2 M and 0.8 M. The concentration of from .25 M to 0.75 M including 0.25 M and 0.75 M is also favorable. In this case, examples of lowest values of the concentration of the catalyst solution are 0.2 M and 0.3 M. Examples of highest values of the concentration of the catalyst solution that may be paired with the aforementioned lowest values are 0.8 M and 0.7 M.

Because the catalyst solution contains no terpineol, on dissolving a transition metal salt in the solvent, terpineol inhibiting solubility is restrained so that solubility of the transition metal salt is ensured. In addition, a problem of a part of the transition metal salt separating as a product of oxidation is restrained so that the catalyst is restrained from deterioration. The solvent may be an organic solvent or water that may dissolve the transition metal salt. Alcohols, for example, ethanol, methanol, propanol, and butanol, and also acetone, acetonitrile, dimethylsulfoxide, and N,N-dimethylformamide are examples of the organic solvent.

In essence, the solvent may be anything that may dissolve the transition metal salt. Electric permittivity of the solvent affects solubility of the transition metal salt so that, considering solubility, the electric permittivity is favorable in a case where dielectric constant is larger. Note that according to a literature, dielectric constant of ethanol is 24. Dielectric constant of methanol is 33. Dielectric constant of water is 80. Dielectric constant of acetonitrile is 37. An organic solvent having dielectric constant equal to or more than 20 is favorable and more favorable if the dielectric constant of the organic solvent is equal to or more than 24.

In a catalyst supporting process, the catalyst particles are caused to be present on the surface of the substrate by making the catalyst solution contact with the surface of the substrate. Arranging aluminum or aluminum alloy that becomes a foundation layer of the catalyst particles on the surface of the substrate prior to processing the catalyst supporting process is favorable. Accordingly, the perpendicular orientation characteristic of the carbon nanotubes may be enhanced. Thickness of aluminum or aluminum alloy may be within a range from 3 to 30 nanometers or within a range from 4 to 20 nanometers.

According to the method according to the present invention, a dipping method, a brush painting method, a roll coating method, a spraying method, and a spin coating method are examples of the method to make a processing liquid contact with the base plate, which in other words is the method to apply the processing liquid to the base plate.

In a carbon nanotubes growing process, a carbon nanotube forming gas of hydrocarbon series is provided to make contact with the surface of the substrate at a temperature within a carbon nanotube forming temperature region to grow a carbon nanotube aggregate on the surface of the substrate, the carbon nanotube aggregate that is aligned in the direction perpendicular to the surface of the substrate. Examples of lengths of the carbon nanotubes are from 20 to 120 micrometers and from 20 to 60 micrometers. In a reaction to form carbon nanotubes, the carbon nanotube forming gas is not limited to a specific type and the processing condition is not limited to a specific condition.

An alcohol series source gas and a hydrocarbon series source gas are examples of the carbon nanotube forming gas that supplies carbon to form the carbon nanotubes. In this case, aliphatic hydrocarbons, for example alkane, alkene, and alkyne, aliphatic compounds, for example alcohol and ethir, and aromatic compound, for example aromatic hydrocarbon, are the examples. Accordingly, a chemical vapor deposition method known as CVD (for example, thermal CVD, plasma enhanced CVD, and remote plasma CVD) exemplifies a method that uses the alcohol series source gas or a source gas of the hydrocarbon series (for example, acethylene, ethylene, mehane, propane, and propylene). Gases of methyl alcohol, ethyl alcohol, propanol, butanol, pentanol, and hexanol are examples of the alcohol series source gas. Furthermore, methane gas, ethane gas, acethylene gas, and propane gas are examples of the hydrocarbon series source gas.

In chemical vapor deposition process, examples of carbon nanotubes forming temperature, which is affected for example by a composition of the carbon nanotube forming gas and a configuration of the catalyst particles, are approximately between 500 and 1200 degrees Celsius, approximately between 550 and 900 degrees Celsius, and approximately between 600 and 850 degrees Celsius. Pressures within a container may be between approximately 100 and 0.1 Mpa. Examples of a temperature of the base plate are approximately between 500 and 1200 degrees Celsius, approximately between 500 and 900 degrees Celsius, and approximately between 600 and 850 degrees Celsius.

### Embodiment 1

Test samples 1 through 12 will be described below. With each of the test samples 1 through 12, a concentration of each of the catalyst solutions is varied at multiple stages within a range between 0.05 M and 1.1 M including the concentration at 0.05 M and 1.1 M. Other conditions are not varied.

Preprocessing of Base Plate

Processed by sputtering, aluminum (which is pure aluminum) that serves as the foundation layer for the catalyst particles is provided as a film on the surface of the base plate (which serves as the substrate). Thickness of the aluminum film is between 4 and 6 nanometers (which is 5 nanometers in the embodiment). Following the aforementioned process, the surface of the base plate is cleansed with acetone. The base plate is a rectangular base plate made of silicon having 4 inches to each side (with thickness of 0.5 millimeters). The conditions mentioned herewith are common in each test samples.

Adjustment of Catalyst Solution

At a normal temperature, iron (III) nitrate nonahydrate is mixed in ethanol, which is an alcohol, to provide a solution having a predetermined concentration. After that, at a normal temperature, the solution is stirred by a stirrer (a stirring machine) to form the catalyst solution. Terpineol is not mixed to the catalyst solution. Accordingly, the catalyst solution is free of terpineol. Furthermore, elements having a characteristic to improve viscocity, for example, sodium polyacrylate, polyvinyl alcohol, polyethylene oxide, polyvinylpyrrolidone, and essential oil, are not mixed. Accordingly, the catalyst solution is free of terpineol, sodium polyacrylate, polyvinyl alcohol, polyethylene oxide, polyvinylpyrrolidone, and essential oil. Upon the arrangement described herewith, in the test sample 1, the catalyst solution is made to have a concentration of 0.05 M. In the test sample 2, the catalyst solution is made to have a concentration of 0.1 M. In the test sample 3, the catalyst solution is made to have a concentration of 0.2 M. In the test sample 4, the catalyst solution is made to have a concentration of 0.3 M. In the test sample 5, the catalyst solution is made to have a concentration of 0.4 M. In the test sample 6, the catalyst solution is made to have a concentration of 0.5 M. In the test sample 7, the catalyst solution is made to have a concentration of 0.6 M. In the test sample 8, the catalyst solution is made to have a concentration of 0.7 M. In the test sample 9, the catalyst solution is made to have a concentration of 0.8 M. In the test sample 10, the catalyst solution is made to have a concentration of 0.9 M. In the test sample 11, the catalyst solution is made to have a concentration of 1 M. In the test sample 12, the catalyst solution is made to have a concentration of 1.1 M.

Coating Method

At a normal temperature, the base plate for each test sample is dipped into the aforementioned catalyst solution corresponding to each of the base plate for ten seconds by using a dip coater. After that, each base plate is pulled out from the catalyst solution with a speed of 60 millimeter/minute. After that, each base plate is dried in 100 degrees Celsius ambient air for five minutes. Accordingly, a catalyst layer having the catalyst particles are formed on the surface of each base plate. Accordingly, a group of a multiple number of catalyst particles forming islands are distributed on the surface of the base plate.

Carbon Nanotubes Forming Method

Using a thermal CVD system, pressure inside a reaction container is adjusted to a state of 0.1 Mpa by introducing nitrogen gas serving as a carrier gas into the reaction container that is vacuumed to a state of 10 Pa in advance. After that, in a state where a temperature of the base plate inside the reaction container is increased to 750 degrees Celsius, a source gas, which is a mixture of acethylene gas with a flow rate of 10 sccm and nitrogen with a flow rate of 45 sccm, is supplied to the reaction container. A unit of sccm is an abbreviation of standard cubic centimeter per minute, which is cubic centimeter per minute standardized at 1 atmosphere and 0 degree Celsius. Then under the source gas atmosphere, reaction is allowed to take place for 10 minutes in a state where the temperature of the base plate is at 750 degrees Celsius and the atmosphere of 266 Pa to form carbon nanotubes on the surface of the base plate. As a result, a carbon nanotube aggregate is formed on the surface of the base plate. Note that the temperature of the base plate is at 750 degrees Celsius, which is a state provided in consideration of enhancing decomposition of a reaction gas on a catalyst, which is a metal salt.

Evaluation

In the aforementioned test samples 1 through 12, the catalyst solutions free of terpineol or a similar viscosity improver are used. In this case, the solvent of the catalyst solution is 100% ethanol. FIG. 1 shows scanning electron microscope images of the carbon nanotubes manufactured as the test samples 1 through 12, where each image represents a different condition of concentration of the catalyst solution. From understanding FIG. 1, in a state where the catalyst solutions free of terpineol are used, according to the test sample 1 (which is provided with a condition where the concentration of the catalyst solution is 0.05 M) the carbon nanotubes did not grow favorably and the perpendicular orientation characteristic of the carbon nanotubes is evaluated as not good. Furthermore, according to the test sample 2 (which is provided with a condition where the concentration of the catalyst solution is 0.1 M) the perpendicular orientation characteristic of the carbon nanotubes is evaluated as not good.

From understanding FIG. 1 further, according to the test sample 3 (which is provided with a condition where the concentration of the catalyst solution is 0.2 M) the perpendicular orientation characteristic of the carbon nanotubes is evaluated as good. Furthermore, according to the test sample 4 (which is provided with a condition where the concentration of the catalyst solution is 0.3 M) the perpendicular orientation characteristic of the carbon nanotubes is evaluated as good. In addition, according to the test sample 5 (which is provided with a condition where the concentration of the catalyst solution is 0.4 M) the perpendicular orientation characteristic of the carbon nanotubes is evaluated as good. Furthermore, according to the test sample 6 (which is provided with a condition where the concentration of the catalyst solution is 0.5 M) the perpendicular orientation characteristic of the carbon nanotubes is evaluated as good. In addition, according to the test sample 7 (which is provided with a condition where the concentration of the catalyst solution is 0.6 M) the perpendicular orientation characteristic of the carbon nanotubes is evaluated as good. Furthermore, according to the test sample 8 (which is provided with a condition where the concentration of the catalyst solution is 0.7 M) the perpendicular orientation characteristic of the carbon nanotubes is evaluated as good. In addition, according to the test sample 9 (which is provided with a condition where the concentration of the catalyst solution is 0.8 M) the perpendicular orientation characteristic of the carbon nanotubes is evaluated as good.

From understanding FIG. 1 even further, according to the test sample 10 (which is provided with a condition where the concentration of the catalyst solution is 0.9 M) the perpendicular orientation characteristic of the carbon nanotubes is evaluated as not good. Furthermore, according to the test sample 11 (which is provided with a condition where the concentration of the catalyst solution is 1 M) the perpendicular orientation characteristic of the carbon nanotubes is evaluated as not good. In addition, according to the test sample 12 (which is provided with a condition where the concentration of the catalyst solution is 1.1 M) the perpendicular orientation characteristic of the carbon nanotubes is evaluated as not good.

Lengths of the carbon nanotubes determined from the scanning electron microscope images are as follows.

Test sample 1 (where the concentration of the catalyst solution is 0.05 M): approximately 3 micrometers

Test sample 2 (where the concentration of the catalyst solution is 0.1 M): approximately from 7 to 30 micrometers

Test sample 3 (where the concentration of the catalyst solution is 0.2 M): approximately 50 micrometers

Test sample 4 (where the concentration of the catalyst solution is 0.3 M): approximately 35 micrometers

Test sample 5 (where the concentration of the catalyst solution is 0.4 M): approximately 60 micrometers

Test sample 6 (where the concentration of the catalyst solution is 0.5 M): approximately 60 micrometers

Test sample 7 (where the concentration of the catalyst solution is 0.6 M): approximately 40 micrometers

Test sample 8 (where the concentration of the catalyst solution is 0.7 M): approximately 25 micrometers

Test sample 9 (where the concentration of the catalyst solution is 0.8 M): approximately 45 micrometers

Test sample 10 (where the concentration of the catalyst solution is 0.9 M): approximately 2 micrometers

Test sample 11 (where the concentration of the catalyst solution is 1 M): approximately 2 micrometers

Test sample 12 (where the concentration of the catalyst solution is 1.1 M): approximately 17 micrometers

From understanding FIG. 1, a knowledge is obtained that by using the catalyst solution, which is a transition metal salt dissolved in a solvent, provided with a predetermined concentration of from 0.2 M to 0.8 M including 0.2 M and 0.8 M and free of terpineol, the carbon nanotube aggregate having a high perpendicular orientation characteristic forms on the surface of the base plate where the carbon nanotubes are aligned in the direction perpendicular to the surface of the base plate. From understanding FIG. 1, the carbon nanotubes grow in a brush form.

To provide a comparison sample, the carbon nanotubes are manufactured by using a catalyst solution containing terpineol. A solvent used in the comparison sample contains a mixture of 80% ethanol and 20% terpineol by mass ratio. The catalyst solution having 0.2 M concentration of iron nitrate dissolved in the solvent described herewith is used. Drying temperature is set to 250 degrees Celsius (note that, the boiling point of terpinol is 221 degrees Celsius). Other conditions are as same as the conditions for test samples 1 through 12.

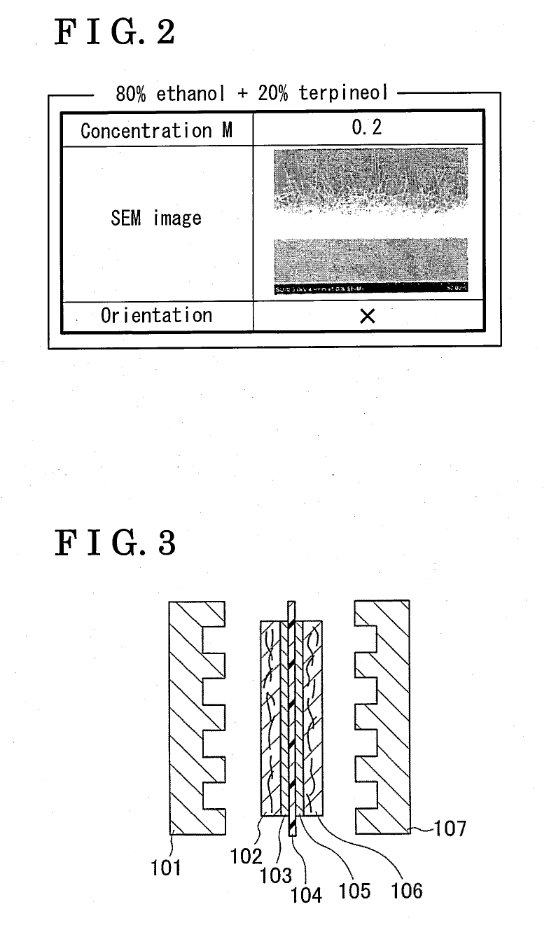

FIG. 2 is a scanning electron microscope image showing the carbon nanotubes manufactured as the comparison sample using the catalyst solution containing terpineol (20% by mass). As FIG. 2 shows, in a state where the catalyst solution containing terpineol, which is a viscosity improver, is used where the nitrate salt concentration is 0.2 M, the carbon nanotubes are oriented in random directions. In comparison, as the image in FIG. 1 at a section that shows iron nitrate concentration of 0.2 M, in a state where the catalyst solution containing no terpineol, which is a viscosity improver, is used where the iron nitrate concentration is 0.2 M, evaluation of the perpendicular orientation characteristic of the carbon nanotubes is evaluated as good.

As described above, according to the aforementioned test samples 1 through 12, the catalyst solutions are free of terpineol, which is a viscosity improver. Terpineol is expensive. Using no terpineol is advantageous with respect to cost. Accordingly, because terpineol is not used, temperature to remove terpineol is not required to increase to the temperature equal to or more than the boiling point of terpineol so that productivity of the carbon nanotubes are increased with respect to time required to manufacturing the carbon nanotubes. Furthermore, because terpineol is not used, on dissolving transition metal salt in the solvent, terpineol inhibiting the dissolving performance is restrained so that the solubility of the transition metal salt in the solvent is ensured. In addition, a problem of a part of the transition metal salt separating as a product of oxidation is restrained so that the catalyst is restrained from deterioration.

Although the catalyst solution provided by transition metal salt dissolved in the solvent is free of terpineol, which is a viscosity improver, the catalyst solution has concentration of from 0.2 M to 0.8 M including 0.2 M and 0.8 M, which is a level of concentration considered as high. By making such high concentration catalyst solution contact with the surface of the substrate (which is the base plate), on an occasion of making the surface of the substrate contact with the catalyst solution, thickness of the catalyst film formed on the surface of the substrate becomes not excessively thin nor excessively thick. Here, in a state where the concentration of the catalyst solution is excessively low, which makes the thickness of the catalyst film in liquid form supported on the surface of the substrate becomes excessively thin, the catalyst particles supported on the surface of the substrate stay in island forms while the islands are largely distanced between one another. In a state where the carbon nanotubes are grown on the surface of the substrate by catalysis of the catalyst particles in this instance, the carbon nanotubes are not aligned in the direction perpendicular to the surface of the substrate and tend to grow slanted relative to the surface of the substrate. In this case, formation of the carbon nanotubes having a high perpendicular orientation characteristic where the carbon nanotubes are aligned in the direction perpendicular to the surface of the substrate is considered difficult.

In comparison, in a state where the concentration of the catalyst solution is excessively high, which makes the thickness of the catalyst film in liquid form provided on the surface of the substrate becomes excessively thick, a degree of agglomeration between the catalyst particles supported on the surface of the substrate is considered high. In a state where the carbon nanotubues are grown on the surface of the substrate by catalysis of the catalyst particles in this instance, the carbon nanotubes are not aligned in the direction perpendicular to the surface of the substrate and tend to grow in various directions and as a result, the perpendicular orientation characteristic of the carbon nanotubes is considered to become rather random. In this case, formation of the carbon nanotubes having a high perpendicular orientation characteristic where the carbon nanotubes are aligned in the direction perpendicular to the surface of the substrate is considered difficult. As described as above, according to the production method according to the embodiment, the carbon nanotube aggregate showing a high perpendicular orientation characteristic is formed on the surface of the substrate where the carbon nanotubes are grown aligned in the direction perpendicular to the surface of the substrate.

### Example of Application 1

FIG. 3 shows a cross sectional view describing substantial parts of a sheet type polymer fuel cell. The fuel cell is formed by laminating, in order in thickness direction, a distribution plate 101 for an anode, a gas diffusion layer 102 for the anode, a catalyst layer 103 for the anode containing catalysts, an electrolyte membrane 104 having ion conducting characteristic (proton conducting characteristic) formed by a polymeric material of fluorocarbon series or hydrocarbon series, a catalyst layer 105 for a cathode containing catalysts, a gas diffusion layer 106 for the cathode, and a distribution plate 107 for the cathode. The gas diffusion layers 102, 106 are provided with permeability to gas so that a reaction gas may permeate. The electrolyte membrane 104 may be formed by using a glass series material having ion conducting characteristic (proton conducting characteristic).

The carbon nanotubes according to this invention may be used in a state where the carbon nanotubes are detached from the base plate and as the gas diffusion layer 102 and/or the gas diffusion layer 106. In this case, because the carbon nanotubes according to this invention are provided with a large specific surface area and are porous, increase of permeability to gas, restraining of flooding, decreasing of electrical resistance, and enhancement of electrical conductivity may be expected. Flooding refers to a phenomenon where liquid state water interfering flow resistance of a flow path of the reaction gas and making the flow resistance of a flow path of the reaction gas small so that permeability of the reaction gas decreases.

Optionally, the carbon nanotubes according to this invention may be used in a state where the carbon nanotubes are detached from the base plate and used for the catalyst layer 103 for the anode and/or the catalyst layer 105 for the cathode. In this case, because the carbon nanotube complex according to this invention is provided with a large specific surface area and is porous, catalyst supporting efficiency may be enhanced. Accordingly, providing adjustment of discharging generated water and adjustment of reaction gas permeability may be expected, which is advantageous in restraining flooding. Furthermore, rate of use of catalyst particles, for example, platinum particles, ruthenium particles, platinum-ruthenium particles, may be enhanced. Note that, the fuel cell is not limited to the sheet type and the fuel cell may be a tube type.

### Example of Application 2

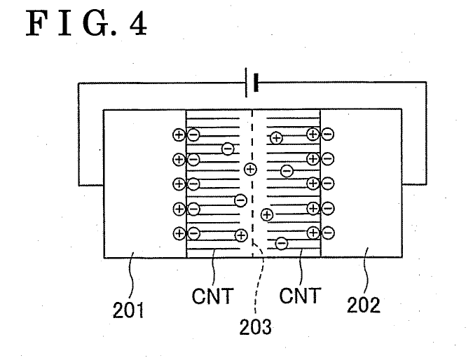

FIG. 4 is a drawing to describe a capacitor for power collection. The capacitor includes a positive electrode 201 formed by a carbon series material and having a porous feature, a negative electrode 202 formed by a carbon series material and having a porous feature, and a separator 203 separating the positive electrode 201 and the negative electrode 202. On a surface of the positive electrode 201, carbon nanotubes having a perpendicular orientation characteristic where the carbon nanotubes are aligned in the direction perpendicular to the surface of the positive electrode 201 are provided. On a surface of the negative electrode 202, carbon nanotubes having the perpendicular orientation characteristic where the carbon nanotubes are aligned in the direction perpendicular to the surface of the negative electrode 202 are provided. The carbon nanotubes according to this invention are provided with a large specific surface area and are porous, so that power collection capacity is expected to increase to enhance capacitor performance in a case where the carbon nanotubes are used for the positive electrode 201 and/or the negative electrode 202. The carbon nanotubes formed on the base plate may be transferred to the surfaces of the negative electrode 202 and/or the positive electrode 201.

### Further Information

In the embodiment 1 corresponding to the above described test samples 1 through 12, ethanol (having the boiling point of 79 degrees Celsius and the dielectric constant of 24) is used as the solvent. Nevertheless, the solvent is not limited to ethanol and instead of ethanol, methanol (having the boiling point of 65 degrees Celsius and the dielectric constant of 33), propanol (having the boiling point of 97 degrees Celsius and the dielectric constant of 20), and additionally, acetone (having the boiling point of 56 degrees Celsius and the dielectric constant of 21), acetonitrile (having the boiling point of 82 degrees Celsius and the dielectric constant of 37), dimethylsulfoxide (having the boiling point of 189 degrees Celsius and the dielectric constant of 47), N,N-dimethylformamide (having the boiling point of 153 degrees Celsius and the dielectric constant of 38), formic acid (having the boiling point of 100 degrees Celsius and the dielectric constant of 58) may be used. Furthermore, water (having the boiling point of 100 degrees Celsius and the dielectric constant of 80) may be used. Considering efficiency of removing the solvent by evaporation, the solvent having low boiling point is favorable, however, the solvent having boiling point equal to or less than 200 degrees Celsius or 150 degrees Celsius may be sufficient and appropriate. In other words, any material that may dissolve iron nitrate or a similar transition metal salt and having the boiling point less than the boiling point of terpineol qualifies as the solvent. Iron nitrate is used as the transition metal salt, however, nickel nitrate, cobalt nitrate, or a similar transition metal salt may be used.

In the embodiment 1 corresponding to the above described test samples 1 through 12, silicon is used as the base material of the substrate, however, the material used for the base material is not limited to such and silicon nitride, silicon carbide, quartz, glass, ceramics, or a metal may be used instead. Alumina and zirconia are examples of ceramics. Iron, iron alloy (stainless steel, for example), copper, copper alloy, titanium, titanium alloy, nickel, nickel alloy, and optionally, aluminum and aluminum alloy are examples of the metal. Form of the substrate is not limited to any one form and may be in a form of a plate, a sheet, a block, or a net. The present invention is not limited to the above described test samples and the embodiment sample and may be appropriately altered within a range where the alteration does not deviate from the essence of the invention.

From the above described specification, following technical ideas may also be grasped.

Additional statement 1 A carbon nanotube production method including processes processed in following order, which are a preparation process preparing a catalyst solution having a predetermined concentration by dissolving a nitrate salt or a similar transition metal salt in a solvent (the catalyst solution having a concentration of from 0.18 M to 0.82 M, including 0.18 M and 0.82 M), the catalyst solution free of terpineol, and preparing a substrate having a surface, a catalyst supporting process making the surface of the substrate to support catalyst particles by making the catalyst solution contact with the surface of the substrate, and a carbon nanotube growing process growing a carbon nanotube aggregate having a perpendicular orientation characteristic on the surface of the substrate where the carbon nanotubes grow in a direction perpendicular to the surface of the substrate by making a carbon nanotube forming gas containing a carbon component contact with the surface of the substrate at a temperature within a carbon nanotube forming temperature region.

### INDUSTRIAL APPLICABILITY

This invention may be applicable to a carbon material requiring a large specific surface area. For example, this invention may be applicable to a carbon material that a fuel cell uses, a carbon material that a battery similar to a capacitor, a secondary battery, or a wet type solar battery uses, a carbon material for a filter of a water purifier, and a carbon material for gaseous adsorption.

1. A carbon nanotube production method, comprising processes processed in following order:
a preparation process preparing a catalyst solution having a predetermined concentration by dissolving a transition metal salt in a solvent, the catalyst solution having a concentration of from 0.2 mole per liter to 0.8 mole per liter including 0.2 mole per liter and 0.8 mole per liter, the catalyst solution free of terpineol, and preparing a substrate having a surface;
a catalyst supporting process making the surface of the substrate support catalyst particles by making the substrate pulled out from the catalyst solution dry in ambient air after dipping the substrate into the catalyst solution; and
a carbon nanotube growing process growing a carbon nanotube aggregate having a perpendicular orientation characteristic on the surface of the substrate where the carbon nanotubes grow in a direction perpendicular to the surface of the substrate by making a carbon nanotube forming gas containing a carbon component contact with the surface of the substrate at a temperature within a carbon nanotube forming temperature region.

2. The carbon nanotube production method according to claim 1, wherein aluminum or aluminum alloy is arranged on the surface of the substrate prior to processing the catalyst supporting process.

3. The carbon nanotube production method according to claim 1, wherein the transition metal salt is at least one of iron nitrate, nickel nitrate, and cobalt nitrate.

4. The carbon nanotube production method according to claim 1, wherein the solvent dissolving the transition metal salt is an organic solvent with dielectric constant of 20 or more, or water.
